(19) United States
(12) Patent Application Publication
(10) Pub. No.: US 2008/0031704 A1
(43) Pub. Date: Feb. 7, 2008

(54) Low Torque Thread Design

(75) Inventor: Donald E. Bobo, Fountain Valley, CA (US)

Correspondence Address: INSKEEP INTELLECTUAL PROPERTY GROUP, INC, 2281 W. 190TH STREET, SUITE 200, TORRANCE, CA, 90504, US

(73) Assignee: InnerSpace Medical, Inc.

(21) Appl. No.: 11/781,016

(22) Filed: Jul. 20, 2007

Related U.S. Application Data
(60) Provisional application No. 60/834,570, filed on Aug. 1, 2006.

(51) Int. Cl. F16B 35/04; B21H 3/02

(52) U.S. Cl. 411/411; 470/9

(57) ABSTRACT

A threaded device such as a self-tapping screw or bolt, particularly for use in medical applications, provides a low-torque design that prevents a steady increase in the amount of torque necessary to drive the device into material as the device progresses. The design includes a thread that has a proximal section with a reduced diameter, thereby reducing the overall contact area between the thread and the material.

### RELATED APPLICATIONS

This application claims priority to U.S. Provisional Application Ser. No. 60/834,570 filed Jul. 20, 2006 entitled A Low Torque Thread Design which is hereby incorporated by reference.

### BACKGROUND OF THE INVENTION

The torque required to twist a threaded screw or bolt into a corresponding hole is directly proportional to the contact surface area of the mating surfaces of the threads and the hole. Hence, as the screw or bolt increases in diameter, the contact surface area increases and the torque required to twist the screw or bolt increases. Similarly, as the screw or bolt advances into the hole, the number of threads (or the length of the single thread) within the hole increases, quickly increasing the contact area and the torque required to continue advancing the screw or bolt. If the screw or bolt is self-tapping, as is often the case with wood screws, or as most applicable to the present invention, bone screws, as opposed to machine screws and pre-threaded holes, the increase in torque required as diameter and depth increases is even more notable due to the tight tolerance between the threads and the newly-cut grooves.

Bolts with hollow cores or through-holes are sometimes used in the medical field to provide an access or pathway through a solid surface which separates two distinct spaces (for example, the inside and outside regions of a human body). Such bolts or implants with hollow cores or through-holes are sometimes used in neurosurgical applications to provide a clean access port to the brain. A hole is drilled through the skull bone of a patient and the bolt is placed through the hole to protect and strengthen the access created by the drill hole, to prevent the inserted tools and instruments from traumatizing brain tissue and to prevent damaging the integrity of the region of the skull surrounding the drill hole. Because hollow core medical bolts are providing access through their centers for medical instruments, they necessarily have larger diameters than solid core bolts used in other medical applications. Additionally, in order to reduce trauma to the patient, it is advantageous to minimize the thickness of the wall between the threads and the hollow core, thereby minimizing the diameter of the hole that must be drilled. Thin-walled hollow core bolts are unable to handle as much torque as thicker-walled or solid core bolts.

Skull bolts are usually screwed in by hand during surgical procedures. The surgeon can easily provide the torque required to screw a small diameter bolt deeply into a drill hole. However, as the bolt diameter approaches 0.25″, the torque required reaches a point where the surgeon is unable to turn the bolt more than several turns thus limiting the length of the bolt engaged in the skull to about 3 mm. The bolt engagement is not enough to prevent the bolt from being knocked out of the drill hole if hit by a fairly modest impact. Screwing the bolt into the skull more deeply increases the amount of the skull supporting the bolt and reduces the lever arm presented by the exposed bolt shaft should a lateral impact occur.

The inability of present bolts to be placed deeply into the drill hole presents a second problem. The problem relates to bolt systems designed to deliver an oxygen probe into an undisturbed part of the brain. The bolt holds a probe deployment device. The deployment device deploys the probe into the brain at an angle to the axis of the drill hole to avoid having the probe come to rest in tissue disturbed by the prior introduction of a drainage catheter. The exit port of the probe deployment device must be below the distal end of the drill hole so the probe does not hit the drill hole wall as it exits the device. The skull bone can be thicker than 20 mm. If a surgeon has difficulty screwing a 20 mm bolt into the skull and stops at 3 mm, the resulting passage for the probe deployment device is 37 mm-20 mm for the skull and 17 mm for the portion of bolt above the skull. Hence, the angle for deploying the probe is significantly reduced when the bolt cannot be screwed all the way into the skull.

Attempts have been made at reducing the amount of torque necessary to advance medical bolts. However, most of these designs do not address the unique problems presented by advancing a hollow core bolt through a skull. For example, U.S. Pat. No. 6,431,869 to Reams III et al., the entire contents of which are incorporated herein, describes a dental implant that includes a thread design that increases in diameter as it progresses from a distal end to a proximal end of a bolt. This thread design also includes segments of the bolt that have been removed, thus the thread is interrupted at several points along its circumference. The resulting geometry is described as a surface that has a series of lobes and dwells. The threads of the lobes interact with the drill hole and no threads are present on the dwells. This design decreases the area contacted by the thread, which in turn reduces the torque required to advance the thread. The torque required to advance the bolt, however, continues to increase directly in proportion to the depth the bolt has progressed down the drill hole. Therefore, the depth to which the bolt can be placed is limited by the torque that can be manually supplied by a surgeon. Because the human skull can be as much as 2 centimeters thick, the torque required to advance even this design would quickly surpass the torque limits of a thin-walled hollow core bolt.

Another example of a prior art attempt at reducing torque is described in U.S. Pat. No. 6,045,312 to Hsing, the entire contents of which are incorporated herein. Hsing is directed to a fastener that reduces tapping torque by providing a first, distal thread that begins on the tapered distal end. A second thread, proximal of the first thread is interwoven between threads of the first thread. Hence, the tapered end need cut only half of the threads as it works to separate the material. The second thread cuts the remaining threads into the sides of the already-established hole. The Hsing fastener, however, still results in increasing torque as the fastener is advanced and would likely still unduly strain a hollow-core bolt in a medical application, such as is addressed by the present invention.

In view of the foregoing, it is apparent that there is a need for alternative thread designs in implants or bolts used in medical applications that reduce torque and, accordingly, facilitate the use of hollow core bolts with thin walls, particularly in applications where the bolts are to be driven through deep, solid material such as the skull.

### SUMMARY OF THE INVENTION

The aforementioned problems are addressed herein by providing a screw or bolt that has a thread with a distal portion and a proximal portion. The distal portion is used for tapping and has a slightly larger diameter than the proximal portion. Hence the contact area of the proximal portion is reduced, thereby reducing the total contact area between the threads and the material through which the bolt is being advanced.

Hence, one aspect of the present invention is to provide a bolt that can be screwed into a hole drilled into the skull bone of a patient to any depth desired.

Another aspect of the present invention is to provide a self-tapping thread wherein the torque required to advance the thread of a bolt into a drilled hole is nearly constant after the distal segment of the thread is fully screwed into the drill hole.

Another aspect of the present invention is to provide a tubular bolt that may be screwed into the skull of a patient manually (e.g., by a surgeon's hand).

### BRIEF DESCRIPTION OF THE DRAWINGS

FIG. 1 illustrates a cross-sectional elevation of one embodiment of a device according to the present invention;

FIG. 2 illustrates a cross-sectional elevation of one embodiment of a device according to the present invention.

### DETAILED DESCRIPTION OF THE INVENTION

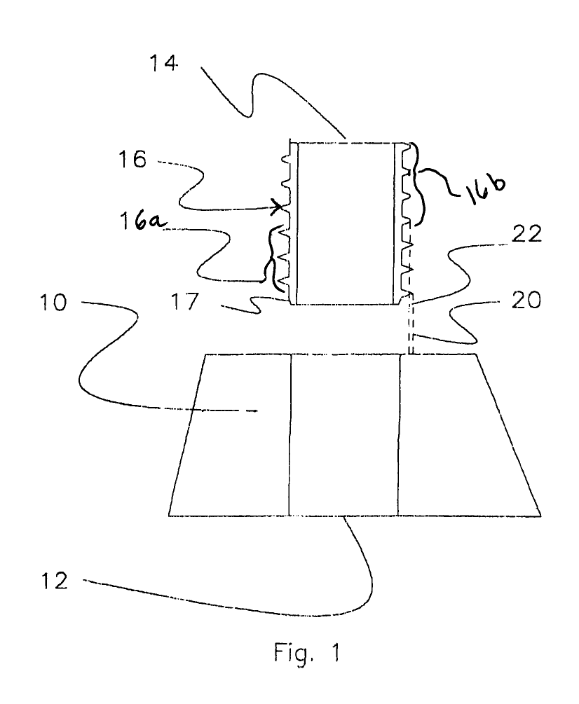

Referring now to FIG. 1, there is shown a skull 10 with a hole 12 drilled in it to accept a hollow-core bolt 14 of the present invention. The bolt 14 includes a thread 16 with a distal section 16a that is distinct from proximal section 16b. The distal section 16a begins at the preferably tapered, distal end 17 of the bolt 14 and is a continuous helix that wraps proximally around the bolt 14. The distal section 16a lends into the proximal section 16b where the threads are reduced in diameter. As shown, the distal section 16a has an outside diameter 20 that is larger than an outside diameter 22 of the proximal section 16b. The distal section 16a of the thread is sharper and acts as self-tapping screw, cutting threads into the inside surface of the hole 12. The proximal section 16b has a chamfered edge, which reduces the contact area between the thread 16b and the skull. The proximal section 16b still provides a desired anchoring force but advances through the threads more easily, thereby requiring an overall reduced torque to advance the bolt 14.

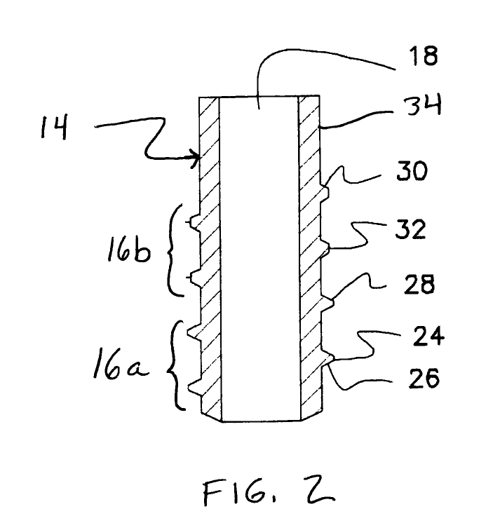

FIG. 2 shows the bolt 12 in greater detail. For the sake of visualization, only two threads of each section 16a and 16b are shown in FIG. 2. The distal section 16a has a thread that has a distal crest 24 that is narrow. The thread height, thread pitch and thread angle collectively define a thread face 26. The distal crest 24 and a portion of the face 26 form a tip 28. The tip profile engages the drill hole 12 with enough force that the bolt 14 can be pulled into the drill hole when turned. The creation of a helical path formed by the thread 16 in the skull 10 requires the thread 16 to apply enough force to compress the bone material of the skull 10 into the desired shape. The contact pressure between the tip 28 and the bone material of the skull 10 is largely responsible for the need to continually increase torque to advance the thread 14. The contact of the tip 28 with the skull 10 normally produces a wedging effect with traditional threads that causes significant drag even though the trailing threads will pass through a helical path that has already been formed by leading threads 16.

Hence, according to the method of the present invention, the tip 28 of the thread 16 is removed from the proximal section 16b by cutting down the OD of the thread 16. The thread profile now consists of a short face 30 and a wide crest 32. Absent the tip 28, the proximal section 16b is not subjected to the resistance to rotation encountered by the distal section 16a. The reduced profile of the proximal section 16b of the thread 14 allows it to move through the helical path formed by the distal section 16a with the application of very little additional torque. The desired combined length of the distal section 16a and proximal section 16b of the thread 14 is only that length required to withstand axial forces. If it is desirable to provide a thread 14 length that is less than the length of the drill hole 12, the body of the bolt 16 can transition to the unthreaded body shown at the proximal end 34 of FIG. 2.

Self-tapping threads come in a variety of profiles. The portion of the distal segment tip that should be removed varies from one profile to another and is also affected by the material into which the thread will be screwed. The length of tip to be removed for a given situation must therefore be determined empirically. As an example, a skull bolt has very narrow threads spaced widely apart. The following non-limiting example provides dimensions used to produce a screw that can be advanced by a nearly constant torque after the distal segment is fully inserted:

### EXAMPLE

The pitch of the thread is 1 mm. The angle of the thread is 30°. The diameter of the drill hole is 0.280.″ The OD of the distal thread segment is 0.300.″ The root diameter of the thread is 0.275″. The height of the thread is 0.01.″ The width of the crest of the distal segment thread is 0.003. The dimensions of the proximal segment are as follows. The height of the thread is 0.0075; the width of the crest is 0.004. The OD of the proximal thread segment is 0.295.″ The interference between the distal segment thread and the drill hole is 0.02.″ The difference between the OD of the distal segment and the OD of the proximal segment is 0.005.″ The length of the distal segment is 4 mm, 1 mm of which is lead in. The length of the proximal segment is 4 mm.

The screw described in this example provides a distal segment long enough to allow the thread to be firmly engaged with the drill hole wall. The length of the proximal section is such that the combined distal and proximal segment length is more than sufficient to withstand axial forces to which the bolt might be subjected. The torque required to advance the bolt is largely limited to the torque required to fully engage the distal segment of the thread. The reduction in the diameter of the proximal segment is sufficient to remove the distal segment tip that would, if retained, cause the torque required to advance the bolt to increase in direct proportion to the depth the screw advances. The truncated proximal segment allows the screw to advance without much additional torque. The outside diameter of the proximal segment thread length is sufficient to stabilize the bolt and keep it from wobbling.

In regards to the optimal reduction in the OD of the distal segment, if the reduction in tip length is too small, the torque required to advance the screw will rise to the point that the surgeon cannot achieve the placement depth desired. If the reduction in tip length is excessive, the contact area between the face of the screw and the helical form will be too little to prevent the bolt from wobbling. The optimal diameter of the proximal segment will depend on the profile of the thread design and the nature of the material into which it is to be screwed. It must be determined empirically.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A threaded device comprising:
a body;
a distal thread section helically surrounding a distal portion of the body;
a proximal thread section helically surrounding a portion of the body proximal of said distal portion;
said distal thread section having an outside diameter greater than an outside diameter of said proximal thread section.

2. The threaded device of claim 1 wherein said body comprises a hollow core.

3. The threaded device of claim 1 wherein said distal thread section and said proximal thread section comprises one continuous thread.

4. The threaded device of claim 1 wherein said body comprises an unthreaded portion proximal of the proximal thread section.

5. The threaded device of claim 1 wherein said distal thread section comprises a self-tapping screw.

6. The threaded device of claim 1 wherein said proximal thread section comprises a chamfered thread.

7. A method of reducing the amount of torque necessary to twist a self-tapping threaded device into material comprising:
providing a self-tapping threaded device having a thread with an outside diameter;
designating a distal section and a proximal section of the thread;
reducing contact area between said proximal section and said material when said self-tapping threaded device is twisted into said material.

8. The method of claim 7 wherein reducing contact area between said proximal section and said material when said self-tapping threaded device is twisted into said material comprises reducing the outside diameter of the proximal section of the thread.

9. The method of claim 7 wherein providing a self-tapping threaded device comprises providing a hollow-core self-tapping threaded device.

10. The method of claim 7 wherein reducing contact area between said proximal section and said material when said self-tapping threaded device is twisted into said material comprises eliminating a tip portion of the proximal section of the thread, thereby creating a wide crest on the proximal section of the thread.

11. The method of claim 7 further comprising:
designating a threadless section proximal of said proximal section;
eliminating all threads from said threadless section.

12. A threaded device useable to twist through a material comprising:
a body;
a distal thread section helically surrounding a distal portion of the body and having a contact area defined as an area of thread that remains in contact with said material as said threaded device is twisted therethrough;
a proximal thread section helically surrounding a portion of the body proximal of said distal portion and having a contact area defined as an area of thread that remains in contact with said material as said threaded device is twisted therethrough;
wherein said distal thread section contact area is greater than said proximal thread section contact area.

13. The threaded device of claim 12 wherein said distal thread section has an outside diameter greater than an outside diameter of said proximal thread section, thereby resulting in said distal thread section contact area being greater than said proximal thread section contact area.

14. The threaded device of claim 12 wherein said body comprises a hollow core.

15. The threaded device of claim 12 wherein said distal thread section and said proximal thread section comprises one continuous thread.

16. The threaded device of claim 12 wherein said body comprises an unthreaded portion proximal of the proximal thread section.

17. The threaded device of claim 12 wherein said distal thread section comprises a self-tapping screw.

18. The threaded device of claim 12 wherein said body further comprises a tapered distal end.

19. The threaded device of claim 14 wherein said hollow core is useable to provide access for tools through said material without causing damage to said material.

20. The threaded device of claim 12 wherein said body and said thread sections form a self-tapping skull bolt.
